(19) United States
(12) Patent Application Publication
(10) Pub. No.: US 2015/0226134 A1
(43) Pub. Date: Aug. 13, 2015

(54) APPARATUS FOR INCREASING VEHICLE DRIVE POWER OUTPUT

(71) Applicant: Pao Shan An, Changhua Hsien (TW)

(72) Inventor: Pao Shan AN, Changhua Hsien (TW)

(73) Assignee: Pao Shan An, Changhua Hsien (TW)

(21) Appl. No.: 14/177,257

(22) Filed: Feb. 11, 2014

(51) Int. Cl. F02D 11/02; F02D 11/10

(52) U.S. Cl. CPC F02D 11/02; F02D 11/106

(57) ABSTRACT

An apparatus for increasing vehicle drive power output includes a control device to be disposed and engaged in a vehicle, an engine sensor electrically connected to the control device, and a regulating device to be disposed and engaged in the vehicle and electrically connected to the control device, the regulating device includes a displayer for displaying information, and includes a control knob for controlling the control device and the engine sensor, and includes a switch for controlling the regulating device. A battery sensor is electrically connected to the control device with a connecting cable. A motor is electrically connected to the control device with a coupling cable.

### BACKGROUND OF THE INVENTION

1. Field of the Invention

The present invention relates to an apparatus for increasing vehicle drive power output, and more particularly to an apparatus for attaching or mounting or engaging into a vehicle cabinet and for economizing the fuel consumption of the vehicle and for increasing vehicle drive power output and for suitably reducing the generation of the carbon dioxide.

2. Description of the Prior Art

Typical apparatuses have been developed and provided for increasing the vehicle drive power output and/or for effecting cooperative control of an automatic transmission, and normally comprise a drive power source which produces a power output to drive and move the vehicle through the automatic transmission and the like.

For example, U.S. Pat. No. 6,432,025 to Kondo et al. discloses one of the typical apparatuses for increasing vehicle drive power output and comprises an automatic transmission incorporating a frictional coupling device which is engaged to place the automatic transmission in a power transmitting state, during power driving of the vehicle with the output of the drive power source, and is released to place the automatic transmission in a power disconnecting state, during coasting of the vehicle. The typical vehicle drive power output increasing apparatus includes a device for determining whether a control initiating condition required to initiate an output increase control for temporarily increasing the output of the drive power source is satisfied or not, depending upon whether an operation to accelerate the vehicle is performed during the vehicle coasting while the frictional coupling device is placed in a released state.

However, the typical apparatuses for increasing vehicle drive power output normally include a complicated structure or configuration that may not be easily made or manufactured by the manufacturers and that may include a complicated making or manufacturing procedure and that may include a greatly increased manufacturing cost.

The present invention has arisen to mitigate and/or obviate the afore-described disadvantages of the conventional apparatuses for increasing vehicle drive power output.

### SUMMARY OF THE INVENTION

The primary objective of the present invention is to provide an apparatus for increasing vehicle drive power output and for attaching or mounting or engaging into a vehicle cabinet and for economizing the fuel consumption of the vehicle and for increasing vehicle drive power output and for suitably reducing the generation of the carbon dioxide.

In accordance with one aspect of the invention, there is provided an apparatus for increasing vehicle drive power output comprising a control device to be disposed and engaged in a vehicle; an engine sensor electrically connected to the control device; and a regulating device to be disposed and engaged in the vehicle and electrically connected to the control device, the regulating device including a displayer for displaying information, and including a control knob for operating and controlling the control device and the engine sensor, and including a switch for controlling the regulating device.

The regulating device includes a setting button for resetting purposes and the like. The engine sensor is electrically connected to the control device with a linking cable or the like for detecting or sensing the driving or rotational speed of the vehicle engine. The linking cable includes a length of about 3 m.

The regulating device is electrically connected to the control device with a signal cable or the like for allowing the control device and the regulating device to be communicated with each other, and for allowing the signals to be transmitted or communicated between the control device and the regulating device. The signal cable includes a length of about 1.2 m.

A battery sensor may further be provided and electrically connected to the control device with a connecting cable or the like for receiving or obtaining the signals from the battery of the vehicle and/or for allowing the battery of the vehicle to supply the electric power to energize the control device and/or the regulating device. The connecting cable includes a length of about 3 m.

A motor may further be provided and electrically connected to the control device with a coupling cable or the like for outputting a power to drive the other facilities or the like. The coupling cable includes a length of about 3 m.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a plan schematic view of an apparatus for suitably increasing the vehicle drive power output in accordance with the present invention.

### DETAILED DESCRIPTION OF THE PREFERRED EMBODIMENT

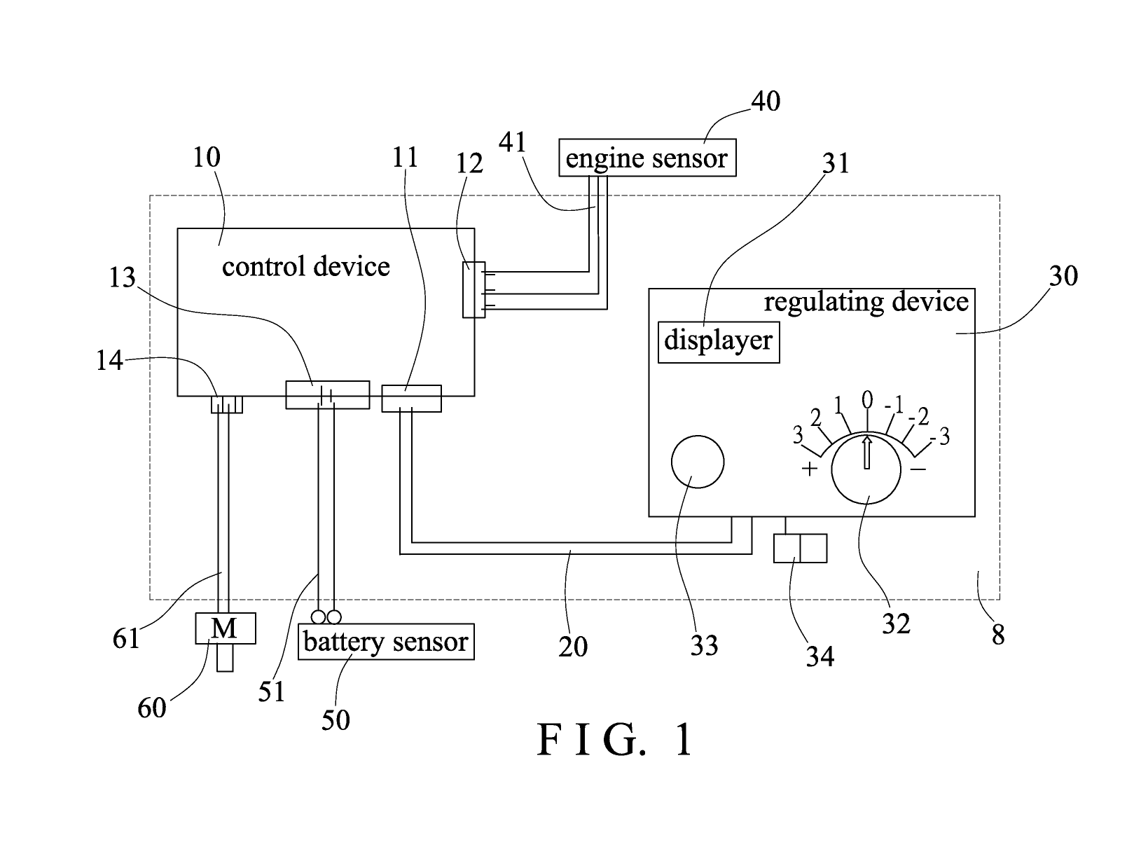

Referring to the drawing FIG. 1, an apparatus for increasing vehicle drive power output in accordance with the present invention comprises a control device 10 and a changing or regulating device 30 disposed or attached or mounted or secured or engaged in a vehicle cabinet 8, the control device 10 includes a first bus or contact or terminal 11 electrically connected or coupled to the regulating device 30 with a signal wire or cable 20 for allowing the control device 10 and the regulating device 30 to be communicated with each other, and for allowing the signals to be transmitted or communicated between the control device 10 and the regulating device 30. It is preferable, but not necessary that the signal cable 20 includes a length of about 1.2 m.

The control device 10 further includes a second bus or contact or terminal 12 electrically connected or coupled to an engine sensor 40 with a linking wire or cable 41 and for detecting or sensing the driving or rotational speed of the vehicle engine (not illustrated), and for selectively increasing the vehicle drive power output of the vehicle engine with the engine sensor 40. It is preferable, but not necessary that the linking cable 41 includes a length of about 3 m. The control device 10 further includes a third bus or contact or terminal 13 electrically connected or coupled to a battery detector or sensor 50 with a connecting wire or cable 51 for receiving or obtaining the signals from the battery of the vehicle (not illustrated) and/or for allowing the battery of the vehicle to supply the electric power to energize the control device 10 and/or the regulating device 30.

The control device 10 further includes a fourth bus or contact or terminal 14 electrically connected or coupled to a motor 60 with a coupling wire or cable 61, and it is preferable, but not necessary that the connecting cable 51 and the coupling cable 61 each include a length of about 3 m. The regulating device 30 includes a screen or window or displayer 31, such as a liquid crystal diode (LCD) displaying unit 31 for showing or displaying the messages or signals or information of the control device 10 and/or the regulating device 30; and includes a switch button or control knob 32 for adjusting or regulating or controlling the control device 10 and/or the battery of the vehicle and/or the motor 60 and/or the vehicle engine; and includes a setting knob or button 33, and a switch 34 for controlling or for switching on and off the regulating device 30.

In operation, as shown in FIG. 1, the control device 10 and the regulating device 30 may be easily and quickly and readily disposed or attached or mounted or secured or engaged in the vehicle cabinet 8 of various kinds of vehicles, and the control device 10 may be electrically connected or coupled to the regulating device 30 and the engine sensor 40 and the battery sensor 50 and the motor 60, and the switch 34 may be used for controlling or switching on the regulating device 30 and for allowing the messages or signals or information of the control device 10 and/or the regulating device 30 to be shown or displayed in the displayer 31 of the regulating device 30; and the control knob 32 may be used for adjusting or regulating or controlling the control device 10 and/or the battery of the vehicle and/or the motor 60 and/or the vehicle engine.

For example, when climbing up a hill or the like, a greater vehicle drive power output is required for driving or moving the vehicle up the hill, and the control knob 32 may be used for adjusting or regulating or controlling the engine sensor 40 and/or the vehicle engine to increase the vehicle drive power output, without depressing the fuel paddle of the vehicle by the user. The fuel consumption of the vehicle may thus be suitably economized, and the vehicle drive power output may be suitably increased, and the generation of the carbon dioxide may be suitably decreased or reduced.

Accordingly, the apparatus for increasing vehicle drive power output in accordance with the present invention may be provided for attaching or mounting or engaging into a vehicle cabinet and for economizing the fuel consumption of the vehicle and for increasing vehicle drive power output and for suitably reducing the generation of the carbon dioxide.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. An apparatus for increasing vehicle drive power output comprising:
a control device to be disposed and engaged in a vehicle;
an engine sensor electrically connected to said control device; and
a regulating device to be disposed and engaged in the vehicle and electrically connected to said control device, said regulating device including a displayer for displaying information, and including a control knob for controlling said control device and said engine sensor, and including a switch for controlling said regulating device.

2. The apparatus for increasing vehicle drive power output as claimed in claim 1, wherein said regulating device includes a setting button.

3. The apparatus for increasing vehicle drive power output as claimed in claim 1, wherein said engine sensor is electrically connected to said control device with a linking cable.

4. The apparatus for increasing vehicle drive power output as claimed in claim 3, wherein said linking cable includes a length of 3 m.

5. The apparatus for increasing vehicle drive power output as claimed in claim 1, wherein said regulating device is electrically connected to said control device with a signal cable.

6. The apparatus for increasing vehicle drive power output as claimed in claim 5, wherein said signal cable includes a length of 1.2 m.

7. The apparatus for increasing vehicle drive power output as claimed in claim 1 further comprising a battery sensor electrically connected to said control device with a connecting cable.

8. The apparatus for increasing vehicle drive power output as claimed in claim 7, wherein said connecting cable includes a length of 3 m.

9. The apparatus for increasing vehicle drive power output as claimed in claim 1 further comprising a motor electrically connected to said control device with a coupling cable.

10. The apparatus for increasing vehicle drive power output as claimed in claim 9, wherein said coupling cable includes a length of 3 m.
